(19) United States
(12) Patent Application Publication
(10) Pub. No.: US 2019/0075319 A1
(43) Pub. Date: Mar. 7, 2019

(54) METHODS FOR PERFORMING AN INTRA PREDICTION ENCODING AND DECODING OF AT LEAST ONE PICTURE, AND CORRESPONDING ELECTRONIC DEVICES

(71) Applicant: InterDigital VC Holdings, Inc., Wilmington, DE (US)

(72) Inventors: Klaus GAEDKE, Hannover (DE); Fabien RACAPE, Rennes (FR); Charlene MOUTON, CESSON SEVIGNE (FR)

(21) Appl. No.: 16/083,494

(22) PCT Filed: Mar. 8, 2017
(86) PCT No.: PCT/EP2017/055493

§ 371 Date: Sep. 8, 2018

(30) Foreign Application Priority Data
Mar. 8, 2016 (EP) 16305260.8

(51) Int. Cl. H04N 19/593; H04N 19/93; H04N 19/186; H04N 19/176; H04N 19/86

(52) U.S. Cl. CPC H04N 19/593; H04N 19/93; H04N 19/86; H04N 19/176; H04N 19/186

(57) ABSTRACT

In one embodiment of the disclosure, it is proposed a method for encoding of at least one picture, said at least one picture being decomposed into a set of blocks. Such method comprises an encoding of at least one block of said set of blocks using intra prediction, and said at least one block comprises pixel values corresponding to either the luma component (L) or chroma components (Cb or Cr). The encoding of said at least one block comprises: obtaining (1301) a set of local minimum and local maximum pixel values within said at least one block; encoding (1302) at least one position information of said pixels corresponding to local minima and local maxima within said at least one block; encoding (1303) pixel values of said set of local minimum and local maximum pixel values.

### TECHNICAL FIELD

The disclosure relates to an intra-frame encoding technique that is used in most source video coding standards such as MPEG-2, AVC, and HEVC.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Intra prediction of macroblocks in the H.264 standard is a spatial encoding technique that uses neighboring information of a macroblock to be encoded. The section 6.3 of the book entitled “the H.264 advanced video compression standard”, 2^{nd} edition, Wiley Publication, by lain E. Richardson, describes some details on how to proceed with the 9 prediction modes available for predictions blocks (see FIG. 1 of the present document).

A spatial encoding technique is also proposed in the HEVC standard, as reminded for example in the chapter 4 of the book entitled “Hight Efficiency Video Coding (HEVC), Algorithms and Architectures” published by Stringer, by V. Sze et al. However, such technique provides much more possibilities and flexibilities (see for example the FIG. 2 of the present document). Indeed, the number of supported intra-predictions modes in the HEVC standard is equal to 33 directional modes (compared to the 8 such modes in H.264), plus a planar mode (surface fitting), and a DC (flat) prediction mode.

Hence both standards apply angular pixel based intra prediction based on the surrounding pixels of a block.

However, such approach is not efficient for encoding noisy regions within pictures. Indeed, when a picture is decomposed into a set of blocks, then the noise present within a block cannot be predicted.

Hence, there is a need to provide an efficient technique for encoding noisy regions within pictures.

### SUMMARY OF THE DISCLOSURE

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present disclosure is directed to a method for encoding of at least one picture, the at least one picture being decomposed into a set of blocks. The method comprises an encoding of at least one block of said set of blocks using intra prediction. The at least one block comprises pixel values corresponding to either luma component (L) or chroma components (Cb or Cr). Such method is remarkable in that said encoding of said at least one block comprises:

obtaining a set of local minimum and local maximum pixel values within said at least one block;

encoding at least one position information of said pixels corresponding to local minima and local maxima within said at least one block;

encoding pixel values of said set of local minimum and local maximum pixel values.

In one embodiment of the disclosure the proposed technique can be used for encoding blocks within homogeneous and noisy regions of a picture (in a video frame for example).

In another embodiment of the disclosure, when a choice of an encoding mode has to be done for encoding a block comprised in an image/picture, the proposed method is used among other encoding techniques, and the selection of the mode to be used is done according to some criteria (such as quality criteria or efficiency compression criteria, etc.). Hence, the proposed technique is not limited to the processing/encoding of homogeneous and noisy regions.

In one embodiment of the disclosure, compared to the prior art techniques, the proposed technique uses a different approach for intra-prediction of blocks within homogeneous and noisy regions of a picture (in a video frame for example). Hence, due to these features, it is possible to perform a kind of noise prediction. This has the advantage that the prediction error is smaller and the coding efficiency is higher. In addition, because the regions are homogeneous, the pixel values for minima (as well as for the maxima) are not very different from each other and can be coded as list of differences very efficiently.

In a preferred embodiment, the method is remarkable in that said obtaining of a set of local minimum and local maximum pixel values is done according to a border scanning order of the pixels for at least one sub-block comprised in said at least one block.

In a preferred embodiment, the method is remarkable in that said encoding pixel values of said set of local minima and local maxima is done based on respectively a difference between a given local minimum and other local minima, and a difference between a given local maximum and other local maxima.

In a preferred embodiment, the method is remarkable in that said encoding at least one position information uses a data compression technique.

In a preferred embodiment, the method is remarkable in that said data compression technique is a run-length encoding which is applied on said position information in which each local minimum of said set is marked with a first value, each local maximum of said set is marked with a second value, and other pixels of said at least one block are marked with a third value.

In a preferred embodiment, the method is remarkable in that said first, second and third values are respectively equal to 1, 2 and 0.

In a preferred embodiment, the method is remarkable in that said run-length encoding is applied on a first position information and a second position information, wherein said first position information comprises local minima marked with a first value and other pixels marked with a second value, and wherein said second position information comprises local maxima marked with said first value and other pixels marked with said second value.

In a preferred embodiment, the method is remarkable in that said first and second values are respectively equal to 1 and 0.

In a preferred embodiment, the method is remarkable in that said given local minimum corresponds to a value belonging to a group comprising:

the smallest value within said set of local minima and local maxima;

an average of local minima within said set of local minima and local maxima;

a median value of local minima within said set of local minima and local maxima.

In a preferred embodiment, the method is remarkable in that said given local maximum corresponds to a value belonging to a group comprising:

the highest value within said set of local minima and local maxima;

an average of local maxima within said set of local minima and local maxima;

a median value of local maxima within said set of local minima and local maxima.

In a preferred embodiment, the method is remarkable in that said at least one sub-block comprised in said block is centered around a centroid of said at least one block.

In a preferred embodiment, the method is remarkable in that said obtaining said set of local minima and local maxima uses at least two sub-blocks, and wherein at least one of the two sub-blocks is the at least one block itself.

In a preferred embodiment, the method is remarkable in that it further comprises determining a reconstructed version of said at least one block from said at least one position information and pixel values from said set of local maxima and minima, said determining comprising:

partially reconstructing said reconstructed version of said at least one block based on said set of local maximum and minimum pixel values, and said at least one position information;

interpolating border missing pixel values of said reconstructed version for at least one sub-block comprised in said at least one block;

interpolating other missing pixel values of said at least partially interpolated reconstructed version based on a path filing strategy between the pixel positions of some minimum value and some maximum value; and

interpolating other missing pixel values of said at least partially interpolated reconstructed version from pixels of said reconstructed version.

In a preferred embodiment, the method is remarkable in that it comprises determining a residual from said at least one block and said reconstructed version of said at least one block, and encoding said residual.

In another embodiment of the disclosure, it is proposed a method for decoding of at least one encoded picture, said at least one encoded picture being decomposed into a set of encoded blocks. The method comprises a decoding of at least one encoded block using intra prediction of said set of encoded blocks. The decoding of said at least one encoded block outputs at least one block comprising pixel values corresponding to either the luma component (L) or chroma components (Cb or Cr). The method is remarkable in that said decoding of said at least one encoded block comprises:

obtaining an encoded residual associated with said at least one encoded block;

decoding said encoded residual delivering a decoded residual;

obtaining prediction information comprising at least one encoded position information, and encoded pixel values corresponding to encoded local minima and encoded local maxima;

determining said at least one block from said decoded residual and said prediction information.

In a preferred embodiment, the method for decoding is remarkable in that it further comprises determining a reconstructed version of said at least one block from said at least one encoded position information and said encoded pixel values. Such determining comprises:

decoding said at least one encoded position information and said encoded pixel values delivering an at least one decoded position information and a set of decoded local minima and decoded local maxima;

partially reconstructing said reconstructed version of said at least one block based on said set of decoded local minima and decoded local maxima, and said at least one decoded position information;

interpolating border missing pixel values of said reconstructed version for at least one sub-block comprised in said at least one block;

interpolating other missing pixel values of said at least partially interpolated reconstructed version based on a path filing strategy between some decoded minimum and some decoded maximum; and

interpolating other missing pixel values of said at least partially interpolated reconstructed version from pixels of said reconstructed version.

According to an exemplary implementation, the different steps of the method are implemented by a computer software program or programs, this software program comprising software instructions designed to be executed by a data processor of a relay module according to the disclosure and being designed to control the execution of the different steps of this method.

Consequently, an aspect of the disclosure also concerns a program liable to be executed by a computer or by a data processor, this program comprising instructions to command the execution of the steps of a method as mentioned here above.

This program can use any programming language whatsoever and be in the form of a source code, object code or code that is intermediate between source code and object code, such as in a partially compiled form or in any other desirable form.

The disclosure also concerns an information medium readable by a data processor and comprising instructions of a program as mentioned here above.

The information medium can be any entity or device capable of storing the program. For example, the medium can comprise a storage means such as a ROM (which stands for “Read Only Memory”), for example a CD-ROM (which stands for “Compact Disc-Read Only Memory”) or a microelectronic circuit ROM or again a magnetic recording means, for example a floppy disk or a hard disk drive.

Furthermore, the information medium may be a transmissible carrier such as an electrical or optical signal that can be conveyed through an electrical or optical cable, by radio or by other means. The program can be especially downloaded into an Internet-type network.

Alternately, the information medium can be an integrated circuit into which the program is incorporated, the circuit being adapted to executing or being used in the execution of the method in question.

According to one embodiment, an embodiment of the disclosure is implemented by means of software and/or hardware components. From this viewpoint, the term “module” can correspond in this document both to a software component and to a hardware component or to a set of hardware and software components.

A software component corresponds to one or more computer programs, one or more sub-programs of a program, or more generally to any element of a program or a software program capable of implementing a function or a set of functions according to what is described here below for the module concerned. One such software component is executed by a data processor of a physical entity (terminal, server, etc.) and is capable of accessing the hardware resources of this physical entity (memories, recording media, communications buses, input/output electronic boards, user interfaces, etc.).

Similarly, a hardware component corresponds to any element of a hardware unit capable of implementing a function or a set of functions according to what is described here below for the module concerned. It may be a programmable hardware component or a component with an integrated circuit for the execution of software, for example an integrated circuit, a smart card, a memory card, an electronic board for executing firmware etc. In a variant, the hardware component comprises a processor that is an integrated circuit such as a central processing unit, and/or a microprocessor, and/or an Application-specific integrated circuit (ASIC), and/or an Application-specific instruction-set processor (ASIP), and/or a graphics processing unit (GPU), and/or a physics processing unit (PPU), and/or a digital signal processor (DSP), and/or an image processor, and/or a coprocessor, and/or a floating-point unit, and/or a network processor, and/or an audio processor, and/or a multi-core processor. Moreover, the hardware component can also comprise a baseband processor (comprising for example memory units, and a firmware) and/or radio electronic circuits (that can comprise antennas) which receive or transmit radio signals. In one embodiment, the hardware component is compliant with one or more standards such as ISO/IEC 18092/ECMA-340, ISO/IEC 21481/ECMA-352, GSMA, StoLPaN, ETSI/SCP (Smart Card Platform), GlobalPlatform (i.e. a secure element). In a variant, the hardware component is a Radio-frequency identification (RFID) tag. In one embodiment, a hardware component comprises circuits that enable Bluetooth communications, and/or Wi-fi communications, and/or Zigbee communications, and/or USB communications and/or Firewire communications and/or NFC (for Near Field) communications.

In one embodiment of the disclosure, the hardware component comprises at least one memory and a CPU (central process unit) connected to said at least one memory, and such hard ware component.

It should also be noted that a step of obtaining an element/value in the present document can be viewed either as a step of reading such element/value in a memory unit of an electronic device or a step of receiving such element/value from another electronic device via communication means.

In one embodiment of the disclosure, it is proposed an electronic device comprising a processor and at least a memory unit coupled to said processor. The processor is configured to encode at least one picture, said at least one picture being decomposed into a set of blocks. In addition, the processor is further configured to encode at least one block of said set of blocks using intra prediction, and said at least one block comprises pixel values corresponding to either the luma component (L) or chroma components (Cb or Cr). The processor is further configured to:

obtain a set of local minimum and local maximum pixel values within said at least one block;

encode at least one position information of said pixels corresponding to local minima and local maxima within said at least one block;

encode pixel values of said set of local minimum and local maximum pixel values.

In another embodiment of the disclosure, it is proposed an electronic device comprising a processor and at least one memory unit coupled to said processor. The processor is configured to decode at least one encoded picture, said at least one encoded picture being decomposed into a set of encoded blocks. In addition, the processor is further configured to decode at least one encoded block using intra prediction of said set of encoded blocks. Moreover, the processor outputs, when it decodes said at least one encoded block, at least one block comprising pixel values corresponding to either the luma component (L) or chroma components (Cb or Cr). The processor is further configured to:

obtain an encoded residual associated with said at least one encoded block;

decode said encoded residual delivering a decoded residual;

obtain prediction information comprising at least one encoded position information, and encoded pixel values corresponding to encoded local minima and encoded local maxima;

determine said at least one block from said decoded residual and said prediction information.

### BRIEF DESCRIPTION OF THE DRAWINGS

The above and other aspects of the invention will become more apparent by the following detailed description of exemplary embodiments thereof with reference to the attached drawings in which:

FIG. 1 presents the approach chosen within H.264/AVC for implementing an intra-prediction of blocks;

FIG. 2 presents the approach chosen within HEVC, that provides more prediction angles compared to the technique used within H.264/AVC;

FIG. 3 presents an example of a homogeneous and noisy 8×8 block, in which some minimum pixel values are marked with a dashed box, and some maximum pixel values are marked with a solid box (in a column per column approach);

FIG. 4 presents another representation of the 8×8 block of FIG. 3, in which the minima are marked with 1, maxima are marked with 2 and the other pixels are marked with 0;

FIGS. 5(a) and 5(b) present two representation of the 8×8 block of FIG. 3. FIG. 5(a) corresponds to a representation in which the minima are marked with 1, and all other pixels are marked with 0. FIG. 5(b) corresponds to a representation in which the maxima are marked with 1, and all other pixels are marked with 0. FIGS. 5(a) and 5(b) represent an alternative to the approach developed in FIG. 4 (for using less marking values compared to FIG. 4);

FIG. 6 presents a partially reconstructed block with minimum pixel values and maximum pixel values, and some interpolated values at the internal border of the block;

FIG. 7 presents the partially reconstructed block of FIG. 6, with some additional interpolated values obtained through the use of paths described in FIGS. 10(a)-(c);

FIG. 8 presents a reconstructed/decoded block from the completion of missing pixels in FIG. 7 based on the use of paths described in FIGS. 10(a)-(c);

FIG. 9 presents a residual block that corresponds to a difference (pixel by pixel) of the block of FIG. 3 with the predicted block (in FIG. 8);

FIG. 10(a)-(c) presents some interpolation paths for an 8×8 block, according to one embodiment of the disclosure;

FIG. 11 presents the output of the transformation of the residual block (i.e. DCT coefficients) according to one embodiment of the disclosure;

FIG. 12 presents the output of the transformation of the residual block (i.e. the DCT coefficients after quantization) according to one embodiment of the disclosure;

FIG. 13 presents a flowchart comprising some steps for performing an intra prediction encoding of at least one block from at least one picture according to one embodiment of the disclosure;

FIG. 14 presents a flowchart comprising some steps for performing an intra prediction decoding of at least one encoded block from an encoded picture according to one embodiment of the disclosure;

FIG. 15 presents an example of a device that can be used to perform one or several steps of methods disclosed in the present document.

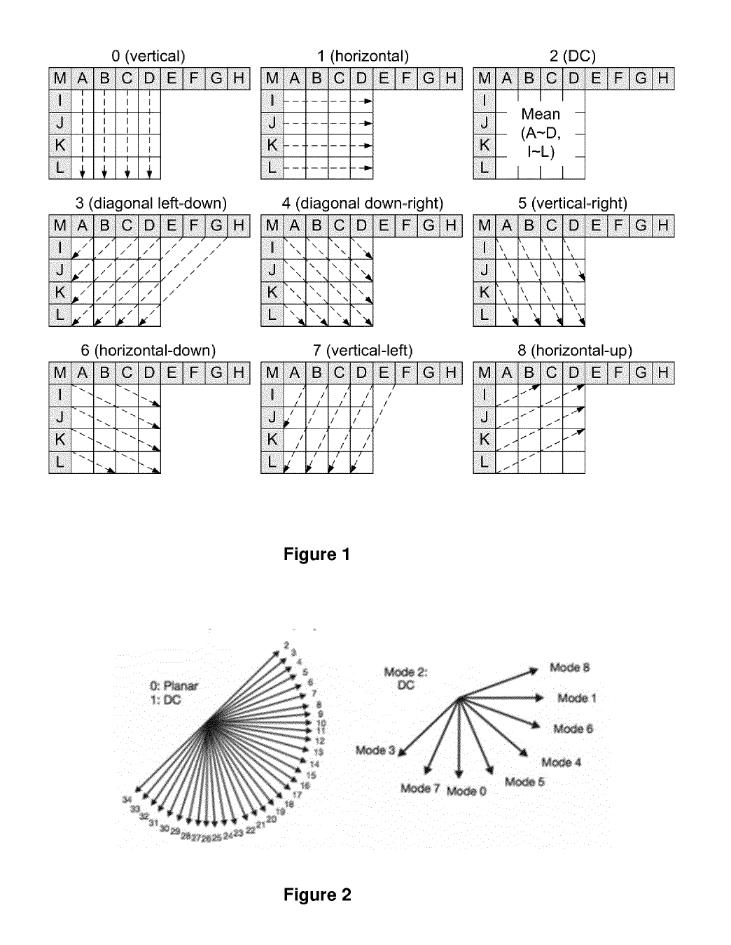

### DETAILED DESCRIPTION

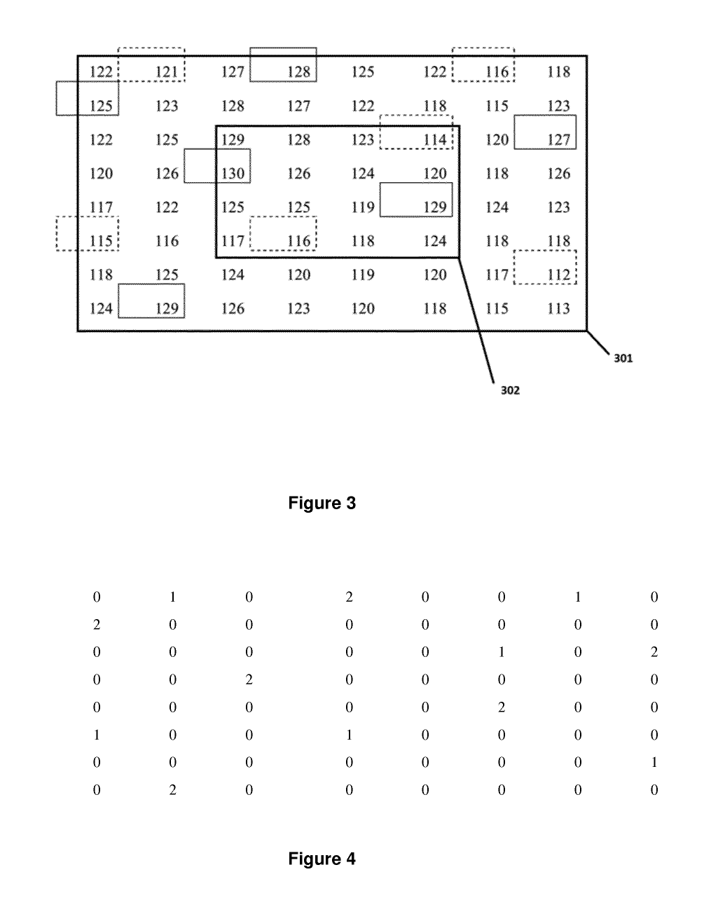

The FIG. 3 presents an example of a homogeneous and noisy 8×8 block, in which local minimum pixel values are marked with a dashed box, and local maximum pixel values are marked with a solid box. The local minima and local maxima are identified as follows: for example, starting from the pixel value 122 (at the top left position of the block) and with a clock-wise border scanning order (from value 122 to value 118, and then from value 118 to value 113, and then from value 113 to value 124, and then from value 124 coming back to the starting value 122), it appears that value 121 is a local minimum and that the value 128 is a local maximum, and so on. It should be noted that, in another embodiment of the disclosure, the border scanning order can be different (i.e. the scanning process can start from another border pixel, and in a different direction (for example an anti-clock-wise border scanning order can be used). Such example will be used in the following in order to describe some of the concepts of the present disclosure.

The values given in the example depicted in FIG. 3 represent the luma (L) component. The processing of the chroma (Cb or Cr) components can be done accordingly.

In one embodiment of the disclosure it is proposed to perform the following process:

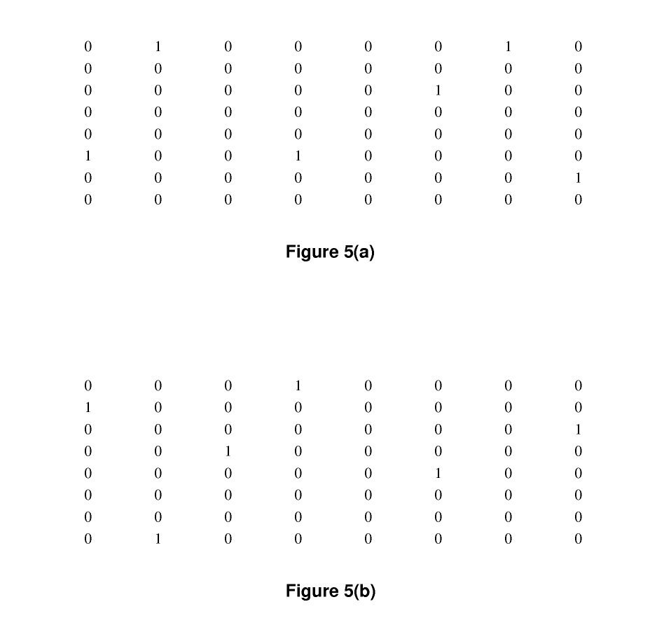

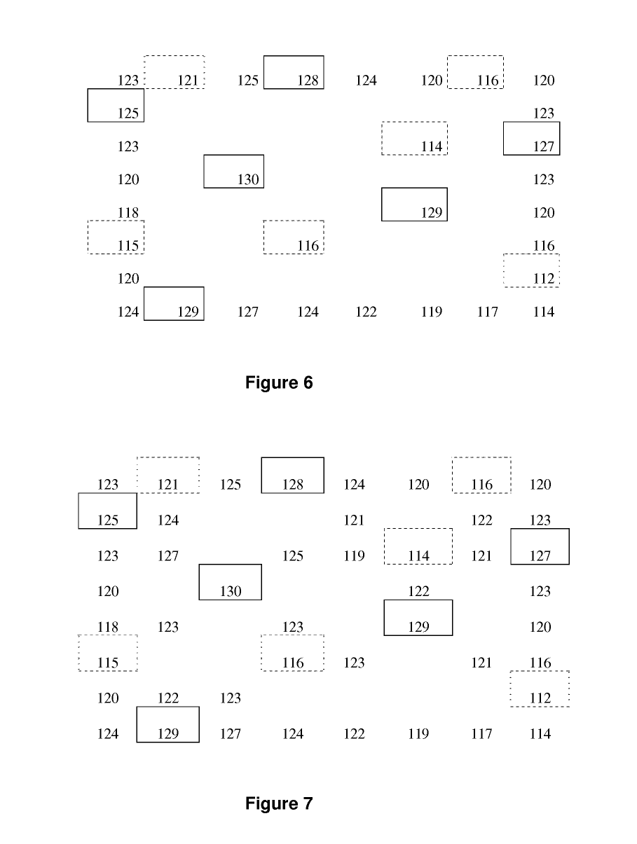

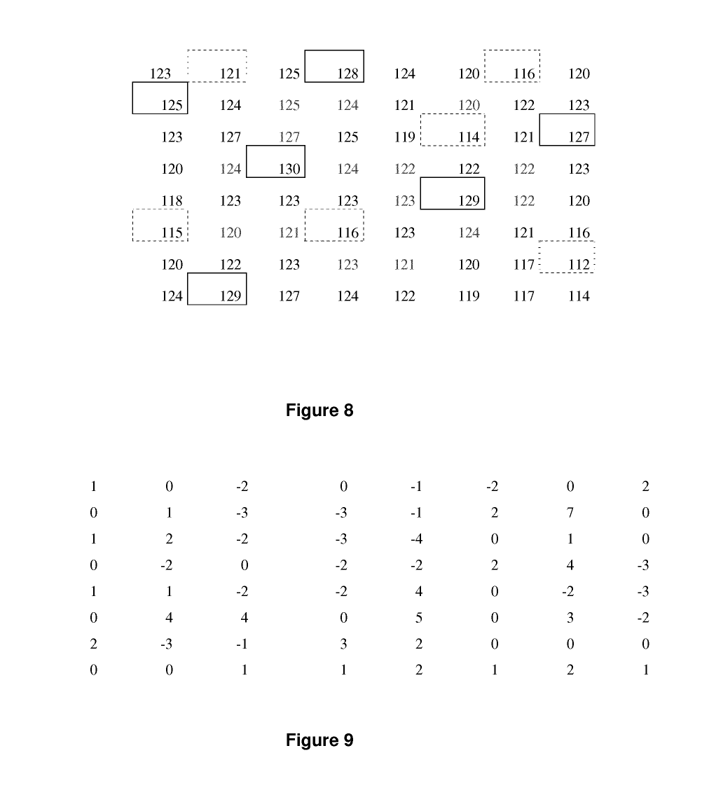

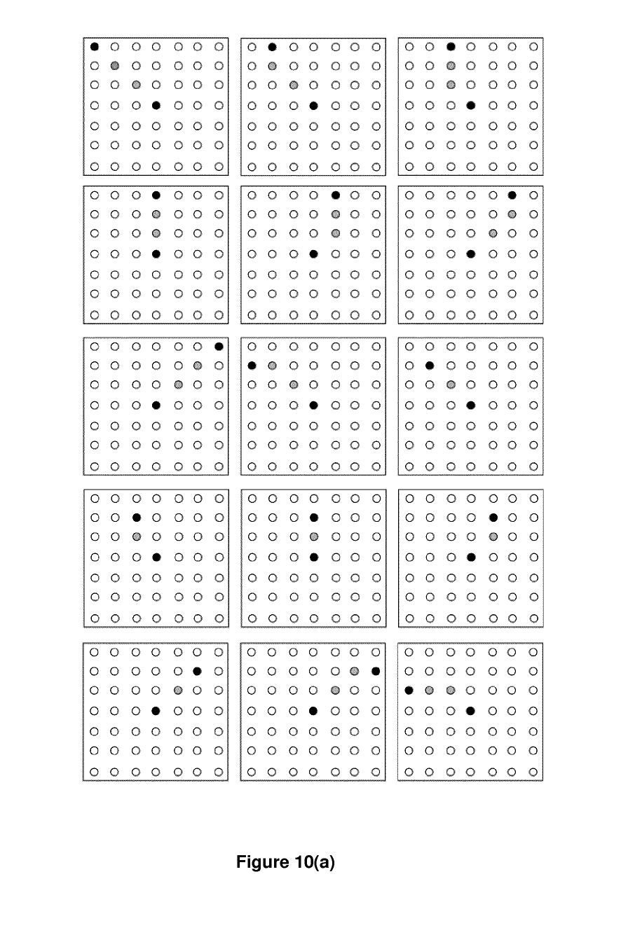

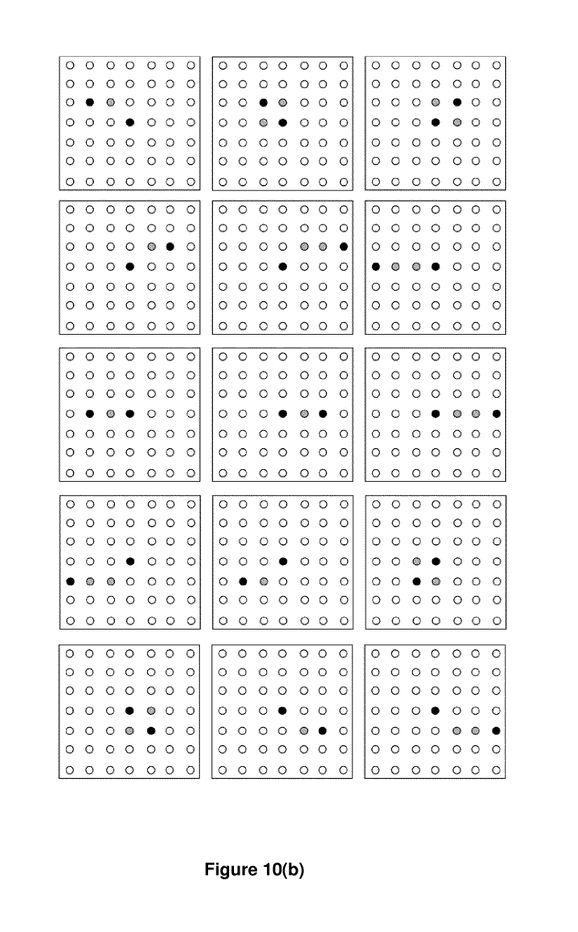

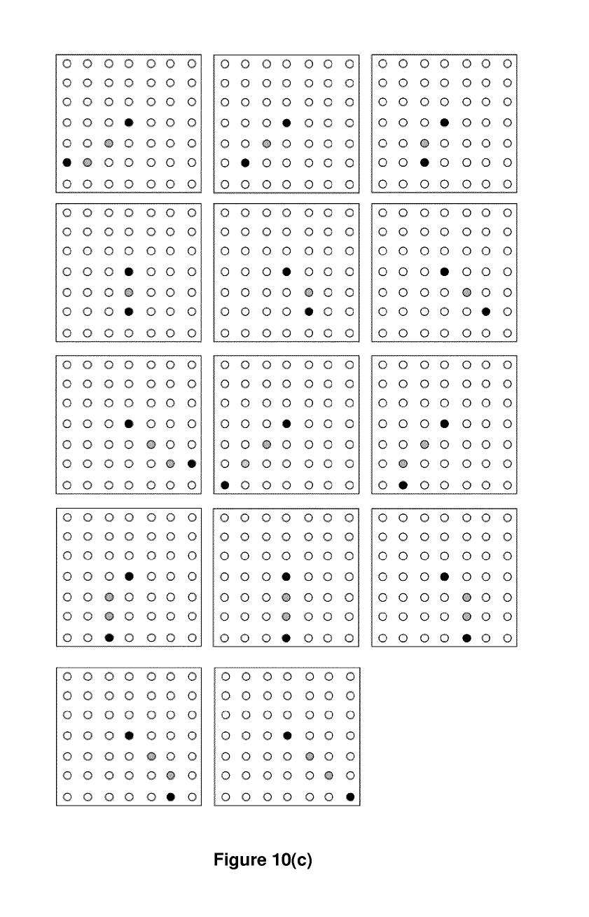

1.) At the boundary of the block, each local minima and each local maxima is marked, e.g. with the values 1 and 2. At last, the pixels between the minima and maxima are marked differently, e.g. with 0.
2.) Inside the block, step one is repeated. The result is shown in FIG. 4 (it should be noted that it is not necessary at the encoding stage to mark the pixels in that order (from the border to the center of the block).
3.) This leads to one position mask/information indicating the positions of minima and maxima which can be encoded and transmitted to the receiver very efficiently, e.g. as list of run-length pairs. Alternatively, also one position mask/information for minima and one position mask/information for maxima may be built (see FIGS. 5(a) and 5(b)). This allows encoding the positions of minima and maxima as 2 run-length lists and may be more efficient. Here is an example of such a list for the minima:
1,4,14,18,2,11,8.
   Given that each value is encoded with 4 bits, this list requires 7*4=28 bits.
   4.) The corresponding list of values for the local minima and local maxima are also encoded. Because the region is homogeneous, the values for local minima are not very different from each other and can be coded as list of differences very efficiently. The local minima are serialized using a horizontal, vertical, zig-zag or any other scanning order. The same applies for the list of local maxima. For example, the list of local minima in a horizontal scanning order for this example would be
121,116,114,115,116,112.
   Transmitting first the minimum value 112 (in a variant, instead of using the smallest minimum, one skilled in the art can use another given minimum such as 115 for example) and then the list of differences results in
9,4,2,3,4,0.
   Given that each value is encoded with 4 bits, this list requires 6*4=24 bits in addition to 8 bits which must be reserved for the minimum value. This can be further reduced if a minimum, median, or average value is chosen for a complete region. In one embodiment of the disclosure, entropy coding may also be used to encode these values.
   5.) The position masks/information and the lists of minima and maxima are used to predict the block. In a first step, the borders of the block are reconstructed using e.g. linear, bi-linear, or bi-cubic interpolation (see FIG. 6). A pre-determined filter may be selected to be used by both the encoder and the decoder or the chosen filter giving the best prediction may be signaled to the receiver. Next, the missing values within the block are interpolated, for example using the paths between the minima and maxima shown in FIG. 10. Again, the interpolation method used at the transmitter may be signaled to the receiver. FIG. 7 shows the result of the descripted interpolation if linear interpolation is used along the paths. The last missing values are finally interpolated from the known ones. This results in the predicted block are shown in FIG. 8.

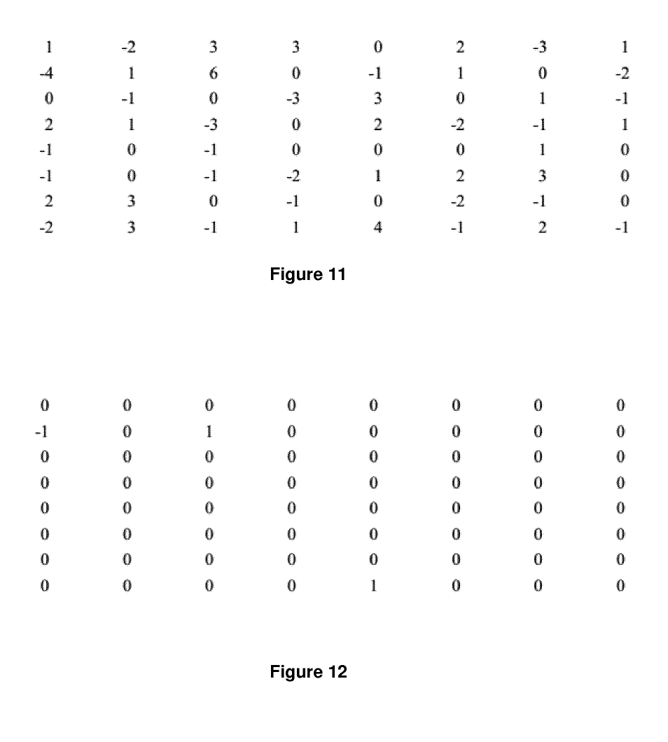

The advantage of the proposed prediction is a significantly reduced prediction error for noisy, homogeneous regions (see the residual block in FIG. 9). After DCT and a fine quantizer, almost no prediction error has to be transmitted (see the encoded residual blocks in FIG. 11 and FIG. 12). This leads to a significant bit rate reduction for intra-frame encoded blocks.

In one embodiment of the disclosure, the encoded residual blocks is transmitted with prediction information (in a specific mode) comprising at least one encoded position mask/information, and encoded pixels corresponding to encoded local minima and encoded local maxima as previously mentioned.

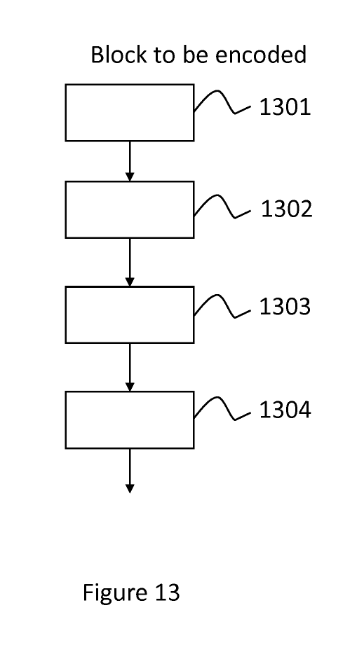

FIG. 13 presents a flowchart comprising some steps for performing an intra prediction encoding of at least one picture according to one embodiment of the disclosure.

In order to perform an intra prediction encoding of a picture (decomposed into a set of blocks, and each block being composed of luma or chroma samples or pixel values), an electronic device obtains a block to be encoded. In one embodiment of the disclosure, one skilled in the art uses a pre-processing technique for detecting/identifying homogeneous and noisy region within the picture in order to select the blocks to be encoded according to the present disclosure. For example, one skilled in the art can use a technique based on the one described in the article entitled “Estimation of the noise level function based on a non-parametric detection of homogeneous image regions” by C. Sutour et al., for detecting/identifying homogeneous and noisy regions. Hence, once these regions have been identified, the blocks comprised in these regions are encoded according to one embodiment of the disclosure. The other blocks can be intra-encoded according to the technique of the prior art.

Then, in a step referenced 1301, the electronic device obtains a set of local minima and local maxima within said at least one block according to a border scanning order of pixels for at least one sub-block comprised in said at least one block. For example, in the previous described embodiment, the electronic device can use a first sub-block, referenced 301 in FIG. 3, being the at least one block itself, and another sub-block included in said block, referenced 302 in FIG. 3, and it can process the pixels located at the internal border of these sub-blocks in order to identify local minima and local maxima. The number of sub-blocks depends on the size of the initial block.

In a step referenced 1302, the electronic device encodes at least one position mask/information of said local minima and local maxima within said block with a data compression technique. For example, in one embodiment of the disclosure, the electronic device can implement the approach developed in link with FIG. 4. In another embodiment of the disclosure, it can implement the approach developed in link with FIGS. 5(a) and 5(b). Hence, in one embodiment of the disclosure, an encoded position mask/information can be represented as a sequence of run length pairs. In another embodiment of the disclosure, two encoded position maps can be represented as 2 run-length lists.

In a step referenced 1303, the electronic device encodes some of said set of local minima and local maxima based on respectively a difference between a given local minimum and other local minima, and a difference between a given local maximum and other local maxima.

Then, a reconstruction process/method is performed by the electronic device in order to obtain a reconstructed version of the block from the encoded set of local minima and local maxima. The electronic device is then able to determine a residual block corresponding to the difference between the reconstructed block and the original block and it encodes it. Such processes are gathered/combined in a step referenced 1304 executed by the electronic device.

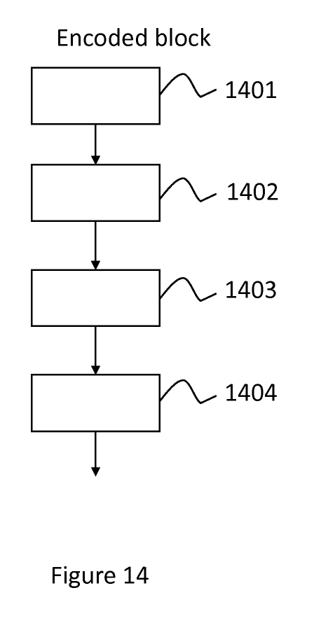

FIG. 14 presents a flowchart comprising some steps for performing an intra prediction decoding of at least one encoded picture according to one embodiment of the disclosure.

In order to perform an intra prediction decoding of an encoded picture (decomposed into a set of encoded blocks), and each block comprising Luma or Chroma samples), an electronic device obtains a block to be decoded (i.e. an encoded block) into a given block.

In a step referenced 1401, the electronic device obtains prediction information comprising at least one encoded position mask/information, and encoded values corresponding to encoded local minima and encoded local maxima.

Then, in a step referenced 1402, the electronic device obtains an encoded residual associated with said at least one encoded block.

In a subsequent step referenced 1403, the electronic device decodes said encoded residual delivering a decoded residual.

At last, the electronic device determines, in a step referenced 1404, said at least one block from said decoded residual and said prediction information.

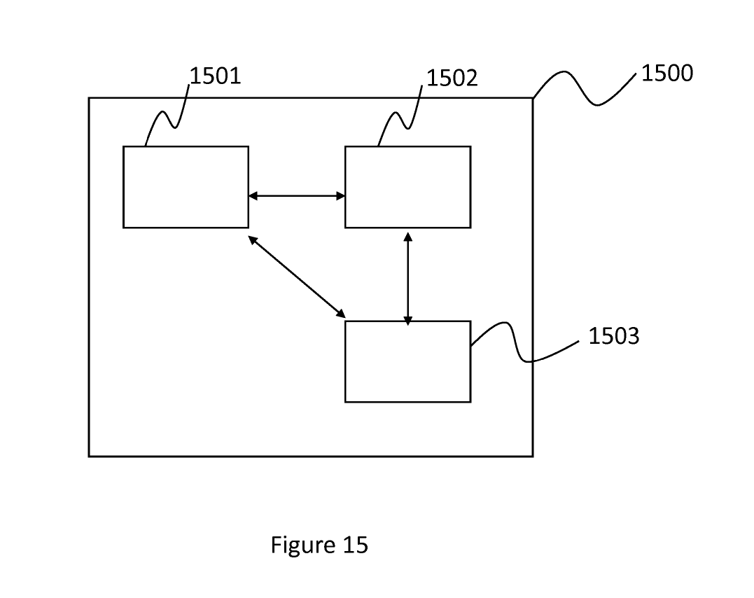

FIG. 15 presents an example of a device that can be used to perform one or several steps of methods disclosed in the present document.

Such device referenced 1500 comprise a computing unit (for example a CPU, for “Central Processing Unit”), referenced 1501, and one or more memory units (for example a RAM (for “Random Access Memory”) block in which intermediate results can be stored temporarily during the execution of instructions a computer program, or a ROM block in which, among other things, computer programs are stored, or an EEPROM (“Electrically-Erasable Programmable Read-Only Memory”) block, or a flash block) referenced 1502. Computer programs are made of instructions that can be executed by the computing unit. Such device 1500 can also comprise a dedicated unit, referenced 1503, constituting an input-output interface to allow the device 1500 to communicate with other devices. In particular, this dedicated unit 1503 can be connected with an antenna (in order to perform communication without contacts), or with serial ports (to carry communications “contact”). It should be noted that the arrows in FIG. 15 signify that the linked unit can exchange data through buses for example together.

In an alternative embodiment, some or all of the steps of the method previously described, can be implemented in hardware in a programmable FPGA (“Field Programmable Gate Array”) component or ASIC (“Application-Specific Integrated Circuit”) component.

In an alternative embodiment, some or all of the steps of the method previously described, can be executed on an electronic device comprising memory units and processing units as the one disclosed in the FIG. 15.

1. A method for encoding of at least one picture, said at least one picture being decomposed into a set of blocks, said method comprising an encoding of at least one block of said set of blocks using intra prediction, and said at least one block comprising pixel values corresponding to either the luma component (L) or chroma components (Cb or Cr), wherein said encoding of said at least one block comprises:
obtaining a set of local minimum and local maximum pixel values within said at least one block;
encoding at least one position information of said pixels corresponding to local minima and local maxima within said at least one block;
encoding pixel values of said set of local minimum and local maximum pixel values.

2. The method according to claim 1, wherein said obtaining of a set of local minimum and local maximum pixel values is done according to a border scanning order of the pixels for at least one sub-block comprised in said at least one block.

3. The method according to claim 1, wherein said encoding pixel values of said set of local minima and local maxima is done based on respectively a difference between a given local minimum and other local minima, and a difference between a given local maximum and other local maxima.

4. The method according to claim 1, wherein said encoding at least one position information uses a data compression technique.

5. The method according to claim 4, wherein said data compression technique is a run-length encoding which is applied on said position information in which each local minimum of said set is marked with a first value, each local maximum of said set is marked with a second value, and other pixels of said at least one block are marked with a third value.

6. The method according to claim 5, wherein said first, second and third values are respectively equal to 1, 2 and 0.

7. The method according to claim 4, wherein said run-length encoding is applied on a first position information and a second position information, wherein said first position information comprises local minima marked with a first value and other pixels marked with a second value, and wherein said second position information comprises local maxima marked with said first value and other pixels marked with said second value.

8. The method according to claim 7, wherein said first and second values are respectively equal to 1 and 0.

9. The method according to claim 3, wherein said given local minimum corresponds to a value belonging to a group comprising:
the smallest value within said set of local minima and local maxima;
an average of local minima within said set of local minima and local maxima;
a median value of local minima within said set of local minima and local maxima.

10. The method according to claim 3, wherein said given local maximum corresponds to a value belonging to a group comprising:
the highest value within said set of local minima and local maxima;
an average of local maxima within said set of local minima and local maxima;
a median value of local maxima within said set of local minima and local maxima.

11. The method according to claim 2, wherein said at least one sub-block comprised in said block is centered around a centroid of said at least one block.

12. The method according to claim 2, wherein said obtaining said set of local minima and local maxima uses at least two sub-blocks, and wherein at least one of the two sub-blocks is the at least one block itself.

13. The method according to claim 1, wherein it further comprises determining a reconstructed version of said at least one block from said at least one position information and pixel values from said set of local maxima and minima, said determining comprising:
partially reconstructing said reconstructed version of said at least one block based on said set of local maximum and minimum values, and said at least one position information;
interpolating border missing values of said reconstructed version for at least one sub-block comprised in said at least one block;
interpolating other missing values of said at least partially interpolated reconstructed version based on a path filing strategy between the pixel positions of some minimum value and some maximum value; and
interpolating other missing values of said at least partially interpolated reconstructed version from pixels of said reconstructed version.

14. The method according to claim 13, wherein it comprises determining a residual from said at least one block and said reconstructed version of said at least one block, and encoding said residual.

15. A method for decoding of at least one encoded picture, said at least one encoded picture being decomposed into a set of encoded blocks, said method comprising a decoding of at least one encoded block using intra prediction of said set of encoded blocks, wherein said decoding of said at least one encoded block outputs at least one block comprising pixel values corresponding to either the luma component (L) or chroma components (Cb or Cr), and wherein said decoding of said at least one encoded block comprises:
obtaining an encoded residual associated with said at least one encoded block;
decoding said encoded residual delivering a decoded residual;
obtaining prediction information comprising at least one encoded position information, and encoded pixel values corresponding to encoded local minima and encoded local maxima;
determining said at least one block from said decoded residual and said prediction information.

16. The method according to 15, wherein it further comprises determining a reconstructed version of said at least one block from said at least one encoded position information and said encoded pixels, said determining comprising:
decoding said at least one encoded position information and said encoded pixels delivering an at least one decoded position information and a set of decoded local minima and decoded local maxima;
partially reconstructing said reconstructed version of said at least one block based on said set of decoded local minima and decoded local maxima, and said at least one decoded position information;
interpolating border missing pixel values of said reconstructed version for at least one sub-block comprised in said at least one block;
interpolating other missing pixel values of said at least partially interpolated reconstructed version based on a path filing strategy between some decoded minimum and some decoded maximum; and
interpolating other missing pixel values of said at least partially interpolated reconstructed version from pixel values of said reconstructed version.

17. A computer-readable and non-transient storage medium storing a computer program comprising a set of computer-executable instructions to implement a method for processing pictures when the instructions are executed by a computer, wherein the instructions comprise instructions, which when executed, configure the computer to perform an encoding method of claim 1.

18. An electronic device comprising a processor and at least a memory unit coupled to said processor, the processor being configured to encode at least one picture, said at least one picture being decomposed into a set of blocks, the processor being further configured to encode at least one block of said set of blocks using intra prediction, and said at least one block comprising pixel values corresponding to either the luma component (L) or chroma components (Cb or Cr), wherein said processor is further configured to:
obtain a set of local minimum and local maximum pixel values within said at least one block;
encode at least one position information of said pixels corresponding to local minima and local maxima within said at least one block;
encode pixel values of said set of local minimum and local maximum pixel values.

19. An electronic device comprising a processor and at least one memory unit coupled to said processor, the processor being configured to decode at least one encoded picture, said at least one encoded picture being decomposed into a set of encoded blocks, the processor being further configured to decode at least one encoded block using intra prediction of said set of encoded blocks, wherein the processor outputs, when it decodes said at least one encoded block, at least one block comprising pixel values corresponding to either the luma component (L) or chroma components (Cb or Cr), and wherein the processor is further configured to:
obtain an encoded residual associated with said at least one encoded block;
decode said encoded residual delivering a decoded residual;
obtain prediction information comprising at least one encoded position information, and encoded pixel values corresponding to encoded local minima and encoded local maxima;
determine said at least one block from said decoded residual and said prediction information.

20. A computer-readable and non-transient storage medium storing a computer program comprising a set of computer-executable instructions to implement a method for processing pictures when the instructions are executed by a computer, wherein the instructions comprise instructions, which when executed, configure the computer to perform a decoding method of claim 15.
